(19) United States
(12) Patent Application Publication
(10) Pub. No.: US 2002/0139565 A1
(43) Pub. Date: Oct. 3, 2002

(54) Electrode cover for training collar

(76) Inventor: Kristopher K. Bradford, Parkesburg, PA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/150,724

(22) Filed: May 17, 2002

Related U.S. Application Data
(62) Division of application No. 09/706,218, filed on Nov. 3, 2000.

(51) Int. Cl. H01B 17/08

(52) U.S. Cl. 174/188

(57) ABSTRACT

An electrode cover is provided having two spaced apart frusto-conical caps. Each cap has an open end leading to a receptacle cavity sized to accept a frusto-conically shaped electrode. A tether is formed integral with and extending between the two caps so as to bind the two caps together at a predetermined distance. A shockless system for training an animal is also provided including an animal collar arrangement comprising an electric shock generator for delivering an electrical shock to an animal under predetermined conditions to control the movement of the animal. A collar is provided for the animal for carrying the electrical shock generator so that electrodes are positioned to engage the animal Advantageously, an electrode cover is provided that includes two spaced apart frusto-conical caps each having an open end leading to a receptacle cavity sized to accept the frusto-conically shaped electrodes. A tether is formed integral with and extending between the two caps so as to bind the two caps together at a distance corresponding to a predetermined distance.

### FIELD OF THE INVENTION

The present invention generally relates to animal containment devices, and more particularly to devices for training an animal to remain within a predetermined area without the use of electric shocks.

### BACKGROUND OF THE INVENTION

A frequent problem attendant with pet ownership is the confinement of an unsupervised pet to a designated area such as the pet owner's yard. Without proper confinement, a pet may run free creating not only a nuisance, but the potential for damage to a neighboring property and endangering the animal itself.

While some pet owners have resorted to fences and other physical barriers to confine the animal, financial and aesthetic considerations often make physical barriers unacceptable. As an alternative to physical barriers for pet confinement, electronic animal confinement systems have been employed. In a conventional electronic animal confinement system, a transmitter is connected to a wire loop antenna having sufficient length to surround a designated area in which the pet is to be confined, such as the home owner's yard. A relatively low frequency signal in a sub-broadcast range of frequencies is transmitted over the wire loop antenna. In order to confine the animal within the area enclosed by the wire loop antenna, an animal collar carrying a signal receiver is placed on the animal. The signal receiver incorporates an electric shock generator which produces an electric shock for transmission to the animal under predetermined conditions. Typically, the electric shock is transmitted to the animal by a pair of electrodes which project from the signal receiver in a position to engage a portion of the animal's body, e.g., the neck region. An example of such a device may be found in U.S. Pat. No. 5,161,485, issued to McDade, which is hereby incorporated by reference.

In certain conventional arrangements, the electrodes also function to attach the signal receiver onto the animal collar. In order to mount the signal receiver on the collar, the electrodes are unscrewed from openings in the signal receiver. Holes in the animal collar are then aligned with the openings in the signal receiver. The electrodes are then inserted through the holes in the animal collar and screwed back into the openings in the signal receiver to thereby attach the signal receiver to the animal collar.

When training an animal to remain within the designated area, it is often desirable to utilize a non-painful means for stimulating the animal, such as a buzzer or bell. Since the shocking delivery electrodes are often used to maintain the signal receiver on the collar, the electrodes cannot be removed from the collar during auditory training. As a consequence, there is a need for an electrode cover suitable for use with a conventional training collar, which will prevent shock delivery during auditory training, while not interfering with the fastening of the signal receiver to the collar.

### SUMMARY OF THE INVENTION

The present invention provides an electrode cover comprising two spaced apart frusto-conical caps. Each cap has an open end leading to a receptacle cavity sized to accept a frusto-conically shaped electrode. A tether is formed integral with and extending between the two caps so as to bind the two caps together at a predetermined distance.

The present invention also provides a shockless system for training an animal including an animal collar arrangement comprising an electric shock generator for delivering an electrical shock to an animal under predetermined conditions to control the movement of the animal. The electric shock generator has a pair of frusto-conical electrodes for transmitting the electric shock to the animal. The electrodes engage the animal to transmit the electrical shock to the animal when exposed, a fastener portion is provided for insertion into the electric shock generator to retain the electrode on the shock generator in position to engage the animal, and a stop portion intermediate the post portion and the fastener portion to limit insertion of the fastener portion into the electric shock generator. A collar is provided for the animal for carrying the electrical shock generator so that the electrodes are positioned to engage the animal Advantageously, an electrode cover is provided that includes two spaced apart frusto-conical caps each having an open end leading to a receptacle cavity sized to accept the frusto-conically shaped electrodes. A tether is formed integral with and extending between the two caps so as to bind the two caps together at a distance corresponding to a predetermined distance.

### BRIEF DESCRIPTION OF THE DRAWINGS

These and other features and advantages of the present invention will be more fully disclosed in, or rendered obvious by, the following detailed description of the preferred embodiment of the invention, which is to be considered together with the accompanying drawings wherein like numbers refer to like parts and further wherein:

FIG. 1 is a partially exploded, perspective view of an electrode cover and shock delivery collar arrangement formed in accordance with the present invention;

FIG. 2 is a perspective view of a fully assembled electrode cover and shock delivery collar arrangement, as shown in FIG. 1; and

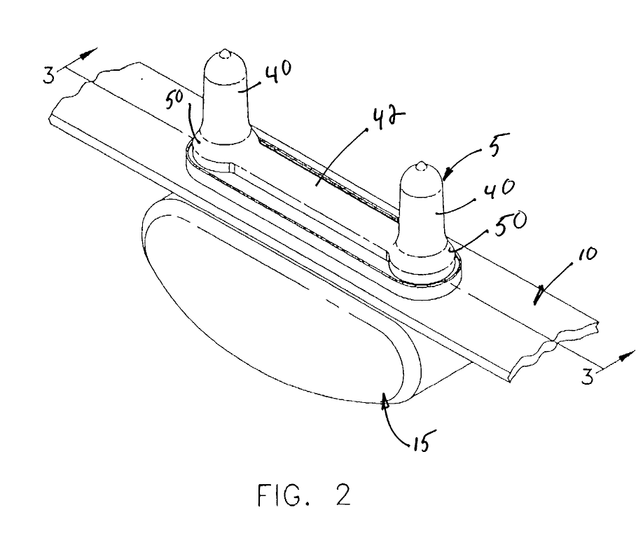

FIG. 3 is a side elevational view of the fully assembled electrode cover and shock delivery collar arrangement shown in FIG. 2, but with the electrode cover shown in cross-section.

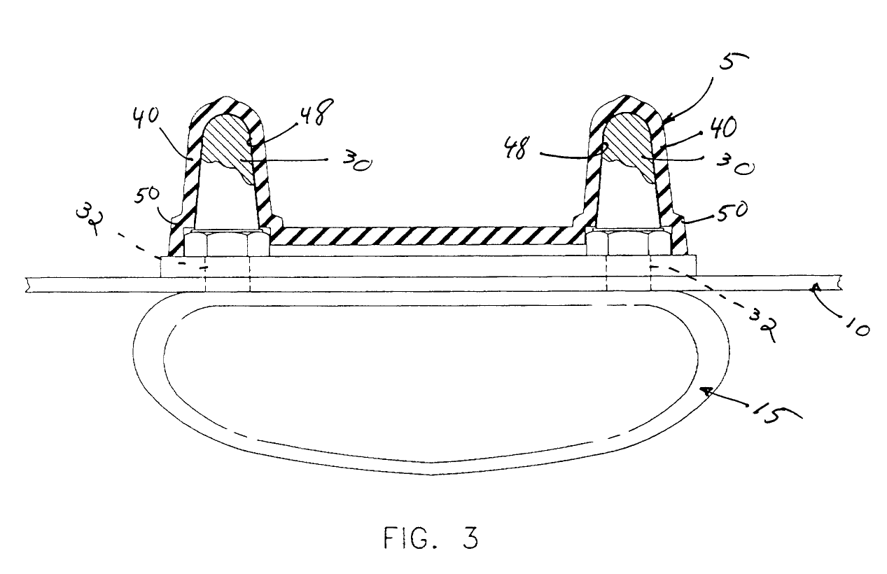

### DETAILED DESCRIPTION OF THE PREFERRED EMBODIMENT

This description of preferred embodiments is intended to be read in connection with the accompanying drawings, which are to be considered part of the entire written description of this invention. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

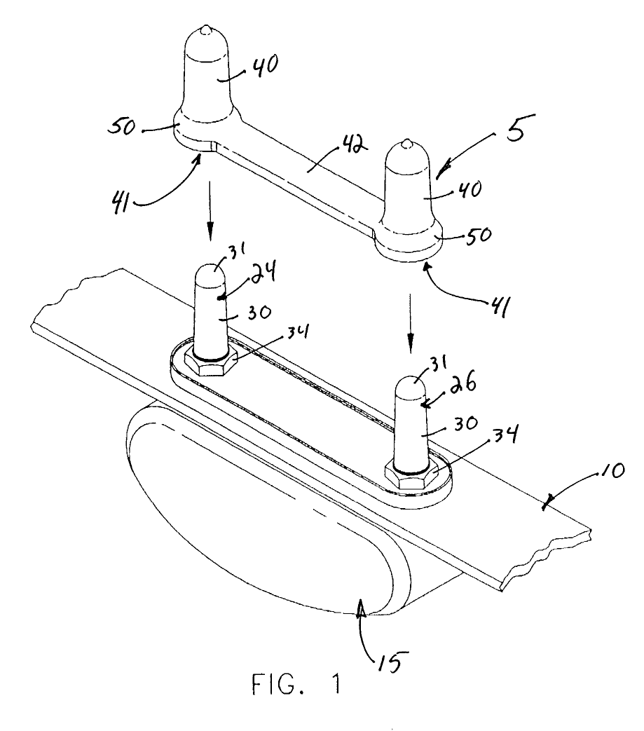

Referring to FIG. 1, shows an electrode cover 5 formed in accordance with the present invention and an animal collar 10 of the type that is employed as part of an electronic animal confinement system. Collar 10, constructed of a suitable material, such as nylon fabric or leather, may be secured around an animal's neck where it administers an electric shock to the animal under predetermined conditions in order to control the movement of the animal. A conventional signal transmitter (not shown) having a conventional wire loop antenna (not shown) is employed as part of the electronic animal confinement system. The wire loop antenna is positioned at a designated confinement area, e.g., buried slightly below the ground along an outer perimeter. During operation, animal collar arrangement 10 responds to the transmitted signal in the wire loop antenna whenever the animal moves within a selected distance from the wire loop antenna. Within the selected distance, animal collar 10 responds to the transmitted signal by functioning to administer a slight electric shock to the animal to deter further movement of the animal toward the antenna.

In order to generate the electric shock, animal collar arrangement 10 includes an electric shock generating signal receiver unit 15 responsive to the transmitted signal in the wire loop antenna for producing an electrical shock. The electric shock generator 15 is carried on animal collar 10.

A pair of electrodes 24,26 are provided on electric shock generator 15 for transmitting the electric shock to the animal. Electrodes 24,26 are constructed of an electrically-conductive metal such as stainless steel or the like. Electrodes 24,26 provide a second feature inasmuch as they act as fasteners to hold shock generator 15 in place on collar 10. As shown in FIG. 1, each of electrodes 24,26 comprises an external post portion 30 having a generally frusto-conical shape with a domed tip 31 for engaging the animal to transmit the electrical shock produced by the electric shock generator 15. Electrodes 24,26 include a fastener portion 32 for insertion through holes in collar 10 and into a respective receptacle opening in shock generator 15. Electrodes 24,26 also include an enlarged stop portion 34 positioned longitudinally intermediate post portion 30 and fastener portion 32. Stop portion 34 of each output terminal 24,26 has the general shape of an enlarged hexagonal bolt head to limit insertion of the fastener portion of the output terminal into its respective receptacle opening in shock generator 15. When fastened to collar 10 and shock generator 15, electrodes 24,26 are arranged with a centerline spacing of about 1.4 to about 1.8 inches or so.

During those times when training is to occur without the use of electric shock stimulus, electrodes 24,26 must be covered to prevent inadvertent shocking. Electrode cover 5 provides a safe and effective dielectric barrier between electrodes 24,26 and the body of the animal being trained. Electrode cover 5 comprises a flexible and compliant dielectric polymer material, such as polyvinylchloride or the like, and includes two terminal caps 40 and a tether 42. More particularly, Caps 40 each comprise a frusto-conical cross-sectional profile having an open end 41 leading to a frusto-conical receptacle space 48 that is sized to receive an output terminal 24,26. An annular shoulder 50 is formed at the base of each cap 40 that is sized to receive stop portion 34. Tether 42 is integral with and extends between caps 40, and is dimensioned so that the central axes of caps 40 are spaced apart at a length that corresponds to the distance between the centerline spacing of electrodes 24,26 when they are assembled to electric shock generator 15, i.e., about 1.4 to about 1.8 inches or so. Thus when electric shocks are not in use during training, one simply slips electrode cover 5 over top of electrodes 24,26 to provide a dielectric barrier. When electric shock stimuli are to be employed, one simply removes electrode cap 5.

It is to be understood that the present invention is by no means limited only to the particular constructions herein disclosed and shown in the drawings, but also comprises any modifications or equivalents within the scope of the claims.

What is claimed is:

1. An electrode cover comprising two spaced apart caps each having an open end leading to a receptacle cavity sized to accept an electrode, and a tether integral with and extending between said two caps so as to bind said two caps together at a distance corresponding to a predetermined distance.

2. An electrode cover according to claim 1 comprising a flexible and compliant dielectric polymer material.

3. An electrode cover according to claim 1 wherein each cap comprises a frusto-conical cross-sectional profile having an open end leading to a frusto-conical receptacle space that is sized to receive an electrode.

4. An electrode cover according to claim 1 wherein an annular shoulder is formed at the base of each cap that is sized to receive a stop portion of an electrode.

5. An electrode cover according to-claim 1 wherein said tether is dimensioned so that said caps are spaced apart at a length that corresponds to the distance between a pair of electrodes positioned on an electric shock generator.

6. A shockless system for training an animal comprising:
an animal collar arrangement including:
an electric shock generator for delivering an electrical shock to said animal under predetermined conditions to control the movement of the animal, the electric shock generator having a pair of electrodes for transmitting the electric shock to the animal, each output terminal being removably insertable into said electric shock generator and including an external post portion for engaging the animal to transmit the electrical shock to the animal, a fastener portion for insertion into said electric shock generator in position to engage said animal, and a stop portion intermediate the post portion and the fastener portion to limit insertion of said fastener portion into said electric shock generator;
a collar for the animal for carrying the electrical shock generator so that the post portions of the electrodes are positioned to engage the animal; and
an electrode cover comprising two spaced apart frusto-conical caps each having an open end leading to a receptacle cavity sized to accept a frusto-conically shaped electrode, and a tether integral with and extending between said two caps so as to bind said two caps together at a distance corresponding to a predetermined distance.

7. An electrode cover according to claim 6 comprising a flexible and compliant dielectric polymer material.

8. An electrode cover according to claim 6 wherein each cap comprises a frusto-conical cross-sectional profile having an open end leading to a frusto-conical receptacle space that is sized to receive an electrode.

9. An electrode cover according to claim 6 wherein an annular shoulder is formed at the base of each cap that is sized to receive a stop portion of an electrode.

10. An electrode cover according to claim 6 wherein said tether is dimensioned so that said caps are spaced apart at a length that corresponds to the distance between said electrodes positioned on said electric shock generator.
